(19) United States
(12) Patent Application Publication
(10) Pub. No.: US 2007/0283384 A1
(43) Pub. Date: Dec. 6, 2007

(54) System and method of providing targeted advertisements

(75) Inventors: Anthony A. Haeuser, Aurora, IL (US); Mary McCarthy, San Antonio, TX (US); Scott A. Pettit, San Antonio, TX (US); Christopher Lee, Lakewood, CO (US); Roland Noll, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/444,261

(22) Filed: May 31, 2006

(51) Int. Cl. H04N 7/025; H04N 7/10

(52) U.S. Cl. 725/34; 725/35

(57) ABSTRACT

The present disclosure is directed to a system and method of providing targeted advertisements. In a particular embodiment, the method includes receiving video content of television programming at a set-top box device from a video server of an Internet Protocol Television (IPTV) system. The method also includes receiving video content of a targeted advertisement at the set-top box device from the video server with the video content of the television programming, where an advertisement server of the IPTV system selects the targeted advertisement based on a customer profile associated with an identifier of the set-top box device. The method also includes recognizing an advertisement insertion point in the video content of the television programming. The method also includes inserting the video content of the targeted advertisement into the video content of the television programming at the advertisement insertion point.

### FIELD OF THE DISCLOSURE

The present disclosure relates generally to providing targeted advertisements.

### BACKGROUND

Television viewing is part of daily life for many people. Most television networks support their programming by charging advertising fees for commercials. Many advertisers use Nielsen ratings and program viewer demographics to evaluate advertisements for their products. Such ratings information includes a sampling of audiences. Thus, advertisers are likely to put their products in front of some disinterested viewers and to miss some interested viewers. Additionally, because television service providers typically offer a wide variety of channels and content, many viewers switch form one network to another during commercial advertisements. For these reasons, advertisers may not realize a return on their commercial advertisements that justifies the fees charged by the networks. The advertisers, in turn, may be less likely to use television commercials as an advertisement means, unless a sufficient number of viewers watch their advertisements. Hence, there is a need for a system and method of providing targeted advertisements.

### BRIEF DESCRIPTION OF THE DRAWINGS

FIG. 1 is a block diagram of a particular illustrative embodiment of a system to provide targeted advertisements;

FIG. 2 is a block diagram of a second particular illustrative embodiment of a system to provide targeted advertisements;

FIG. 3 is a block diagram of a third particular illustrative embodiment of a system to provide targeted advertisements;

FIG. 4 is a flow diagram of a particular illustrative embodiment of a method of providing targeted advertisements;

FIG. 5 is a flow diagram of a second particular embodiment of a method of providing targeted advertisements;

FIG. 6 is a flow diagram of a third particular illustrative embodiment of a method of providing targeted advertisements;

FIG. 7 is a flow diagram of a fourth particular illustrative embodiment of a method of providing targeted advertisements; and

FIG. 8 is a diagram of an illustrative embodiment of a general computer system.

### DETAILED DESCRIPTION OF THE DRAWINGS

The present disclosure is directed to a set-top box device that includes a processor and a memory device accessible to the processor. The set-top box device also includes a buffer to receive video content of television programming from a video server of an Internet Protocol Television (IPTV) system. The set-top box device also includes an advertisement store to receive video content of a targeted advertisement from the video server with the video content of the television programming, where an advertisement server of the IPTV system selects the targeted advertisement based on a customer profile associated with an identifier of the set-top box device. Further, the memory device includes an advertisement insertion module executable by the processor to recognize an advertisement insertion point in the video content of the television programming and to insert the video content of the targeted advertisement into the video content of the television programming at the advertisement insertion point.

In another embodiment, the disclosure is directed to a method of providing targeted advertisements that includes receiving video content of television programming at a set-top box device from a video server of an Internet Protocol Television (IPTV) system. The method also includes receiving video content of a targeted advertisement from the video server with the video content of the television programming, where an advertisement server of the IPTV system selects the targeted advertisement based on a customer profile associated with an identifier of the set-top box device. The method also includes recognizing an advertisement insertion point in the video content of the television programming and inserting the video content of the targeted advertisement into the video content of the television programming at the advertisement insertion point.

In another embodiment, the disclosure is directed to a computer program embedded in a computer-readable medium. The computer program includes instructions to receive video content of television programming from a video server of an Internet Protocol Television (IPTV) system. The computer program also includes instructions to receive video content of a targeted advertisement from the video server with the video content of the television programming, where an advertisement server of the IPTV system selects the targeted advertisement based on a customer profile associated with an identifier of the set-top box device. The computer program also includes instructions to recognize an advertisement insertion point in the video content of the television programming and to insert the video content of the targeted advertisement into the video content of the television programming at the advertisement insertion point.

In another embodiment, the disclosure is directed to a system that includes a video server configured to send video content of television programming to a set-top box device via an access network of an Internet Protocol Television (IPTV) system, where the video server includes a processor and a memory device. The memory device includes instructions executable by the processor to identify an advertisement insertion point in the video content of the television programming and to issue a request to an advertisement server of the IPTV system to receive at least one advertisement to be sent to the set-top box device. The request can include an identifier of the set-top box device. In addition, the memory device includes instructions executable by the processor to insert video content of a targeted advertisement received from the advertisement server into the video content of the television programming, the advertisement server selecting the targeted advertisement based on a profile associated with the identifier of the set-top box device. In a particular embodiment, the profile can include telephone call history data.

In another embodiment, the disclosure is directed to a method of providing targeted advertisements that includes receiving a customer profile associated with an identifier of a set-top box device at an advertisement server of an Internet Protocol Television (IPTV) system, where the customer profile is based at least partially on telephone call history data and indicates a customer preference for at least one product, at least one service, or any combination thereof. The method also includes selecting at least one advertisement in response to a request for at least one advertisement to be sent to the set-top box device, wherein the customer profile at least partially matches an intended target of the at least one selected advertisement.

In another embodiment, the disclosure is directed to a method of providing targeted advertisements that includes receiving customer information associated with a set-top box device, where the customer information includes telephone call history data. The method also includes creating a customer profile based on the customer information and associating the customer profile with an identifier of the set-top box device. The method also includes sending the customer profile with the identifier to an advertisement server of an Internet Protocol Television (IPTV) system, where the advertisement server selects at least one advertisement based on the customer profile and wherein video content the at least one advertisement is included with video content of television programming sent to the set-top box device via an access network of the IPTV system.

In another embodiment, the disclosure is directed to a method of providing targeted advertisements that includes sending video content of television programming to a set-top box device from a video server of an Internet Protocol Television (IPTV) system. The method also includes identifying an advertisement insertion point in the video content of the television programming. The method also includes issuing a request to an advertisement server of the IPTV system to receive video content of an advertisement to be sent to the set-top box device, where the request includes an identifier of the set-top box device. Further, the method includes receiving video content of a targeted advertisement from the advertisement server, where the advertisement server selects the targeted advertisement based on a customer profile associated with the identifier of the set-top box device, the customer profile including telephone call history data.

In another embodiment, the disclosure is directed to a computer program embedded in a computer-readable medium. The computer program includes instructions to store video content a plurality of advertisements. The computer program also includes instructions to receive a profile associated with an identifier of a set-top box device of an Internet Protocol Television (IPTV) system, where the profile is based at least partially on telephone call history data. The computer program also includes instructions to select an advertisement from the plurality of advertisements based on the profile, where the profile at least partially matches an intended target of the selected advertisement.

In another embodiment, the disclosure is directed to a computer program embedded in a computer-readable medium. The computer program includes instructions to send video content of television programming to a set-top box device via an access network of an Internet Protocol Television (IPTV) system. The computer program also includes instructions to identify an advertisement insertion point in the video content of the television programming and to issue a request to an advertisement server of the IPTV system to receive at least one advertisement to be sent to the set-top box device, the request including an identifier of the set-top box device. The computer program also includes instructions to insert video content of a targeted advertisement received from the advertisement server into the video content of the television programming, the advertisement server selecting the targeted advertisement based on a profile associated with the identifier of the set-top box device, the profile including telephone call history data.

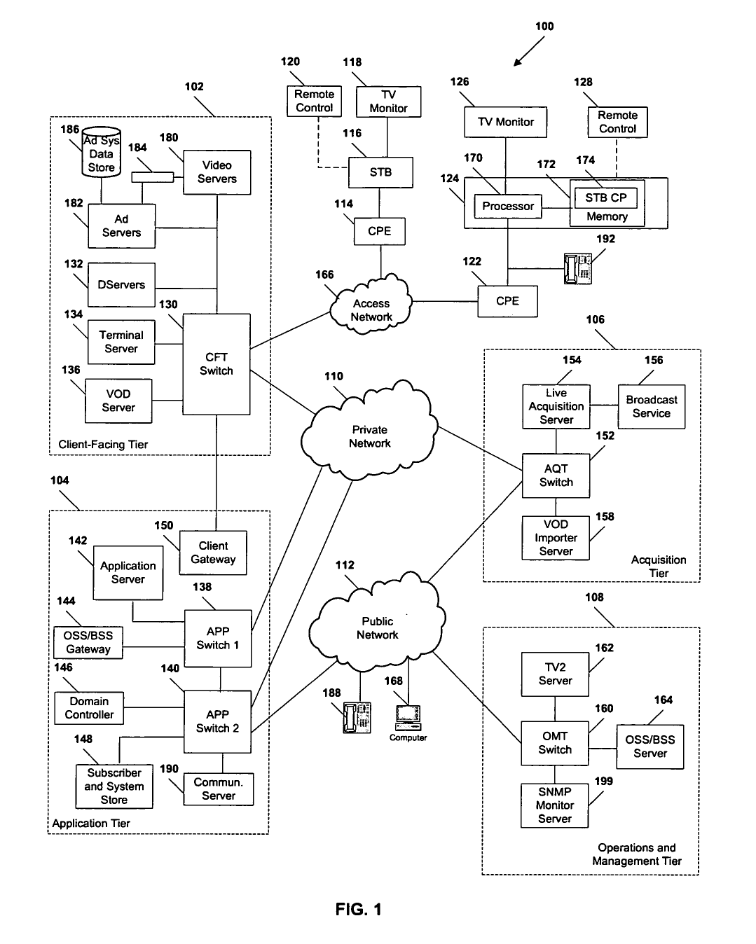

Referring to FIG. 1, an illustrative embodiment of an Internet Protocol Television (IPTV) system that may be used to provide one or more targeted advertisements is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch or router of the access network 166. The client-facing tier 102 can communicate with a first representative set-top box device 116 at a first customer premise via the first CPE 114 and with a second representative set-top box device 124 at a second customer premise via the second CPE 122. The CPE 114, 122 can include routers, local area network devices, modems, such as digital subscriber line (DSL) modems, any other suitable devices for facilitating communication between a set-top box device and the access network 166, or any combination thereof.

In a particular embodiment, the client-facing tier 102 can be coupled to the CPE 114, 122 via fiber optic cables. Alternatively, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the private access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100.

Further, the CFT switch 130 is coupled to one or more video servers 180 that receive video content and transmit the content to the access network 166 via the CFT switch 130. In a particular embodiment, the CFT switch 130 can be coupled to one or more advertisement servers 182 that store advertisements. In an illustrative, non-limiting embodiment, the advertisement server(s) 182 can be coupled to the video server(s) via a splicer 184. In addition, the advertisement server(s) 182 can be coupled to one or more advertising system data stores 186 that store intended target criteria and other information related to the advertisements stored at the advertisement server(s) 182. Moreover, the advertising system data store(s) 186 can store customer profiles associated with the set-top box devices 116, 124.

In an illustrative embodiment, the client-facing tier 102 can communicate with a large number of set-top boxes, such as the representative set-top boxes 116, 124 over a wide geographic area, such as a regional area, a metropolitan area, a viewing area, a designated market area or any other suitable geographic area, market area, or subscriber or customer group that can be supported by networking the client-facing tier 102 to numerous set-top box devices. In a particular embodiment, the client-facing switch 130, or any portion thereof, can be a multicast router or switch that feeds one or more video streams from a video server to multiple set-top box devices.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the system 100 via the private network 110 or the public network 112. In an illustrative embodiment, the subscriber and system store 148 can store subscriber or customer data and create subscriber or customer profiles that are associated with IP addresses of corresponding set-top box devices 116, 124.

In another illustrative embodiment, the second APP switch 140 can be coupled to one or more communication servers 190 that can connect calls from user telephones 188, 192 with source or destination devices via the access network 166, the public network 112, a public switched telephone network (PSTN), another telephone network, or any combination thereof. In a particular embodiment, the communication server(s) 190 can collect telephone call history data, such as locations from which a customer has received calls, locations to which a customer has placed calls, or any combination thereof. The communication server(s) 190 can store the telephone call history data and send it to the subscriber and system store 148, a data store of the access network 166, another device within the IPTV system 100, or any combination thereof, where the information can be used in the creation of customer profiles. In an illustrative, non-limiting embodiment, a service provider can obtain any necessary consents from customers prior to the communication server(s) 190 collecting the telephone call history data. In another embodiment, the communication server(s) 190 can collect the telephone call history data without such consents, for example, where such consents are not required by regulation.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. Advertisement content can be stored with or without such manipulation at the advertisement server(s) 182 until it is requested by the video server(s) 180. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 199 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer (PC) coupled to the public network 112.

In a particular illustrative embodiment, customer information associated with the set-top box devices 116, 124 can be stored at a data store coupled to a local switch of the access network 166. For example, the customer information can include viewing habits at the set-top box devices 116, 124; age, gender, marriage, children or other demographic information associated with customers or users of the set-top box devices 116, 124; and other information that can be related to preferences or interests associated with customers or users of the set-top box devices 116, 124. In a particular embodiment, the customer information can include telephone call history data associated with customers or users of the set-top box devices 116, 124, Internet viewing habits associated with customers or users of the set-top box devices 116, 124, or any combination thereof. In an illustrative, non-limiting embodiment, a service provider can obtain any necessary consents from customers prior to collecting the telephone call history data, Internet viewing habits, or any combination thereof. In another embodiment, the service provider can collect the telephone call history data, Internet viewing habits, or any combination thereof, without such consents, for example, where such consents are not required by regulation.

In a particular embodiment, the data store can receive and store at least a portion of the customer information from the communication server(s) 190, subscriber and system store 148 or another device of the IPTV system 100. In another particular embodiment, at least a portion of the customer information can be collected at the local switch.

In an illustrative embodiment, customer information stored at the access network 166 can be used to develop customer profiles that are associated with IP addresses of various set-top box devices. For instance, a customer profile can predict or otherwise indicate, for example, needs, wants, preferences, interests, or any combination thereof, for goods, services, or any combination thereof, at a customer's household. In an exemplary embodiment, a first customer profile associated with the first representative set-top box device 116 can be associated with an IP address of the first representative set-top box device 116, and a second customer profile associated with the second representative set-top box device 124 can be associated with an IP address of the second representative set-top box device 124. The customer profiles and associated IP addresses can be sent from the access network 166 to the advertising system data store(s) 186 at the client-facing tier 102.

In an illustrative embodiment, advertisements can be received at the acquisition tier 106, for example, via the broadcast service 156. Such advertisements are sent to the advertisement server(s) 182 and stored. The advertising system data store(s) 186 can store information associated with advertisements stored at the advertisement server(s) 182, such as advertisement identifiers, advertisement lengths, advertisement subject matter, advertiser name, product name, profiles of intended advertisement targets, other information related to advertisements stored at the advertisement server(s) 182, or any combination thereof.

Further, the advertising system data store(s) 186 can store information related to advertisements stored at the advertisement server(s) 182. For example, the advertising system data store(s) 186 can store an identifier of each one of the advertisements stored at the advertisement server(s) 182. Further, advertising system data store(s) 186 can store one or more indicators associated with each advertisement, each indicator identifying a time, program, network, advertisement insertion point, or any combination thereof, at which an advertisement is to be displayed (e.g., the 15:52 point of FOX's ‘24’). In addition, the advertising system data store(s) 186 can store intended target information related to each one of the advertisements stored at the advertisement server(s) 182, which can be compared to customer profiles stored at the advertising system data store(s) 186. Intended target information can include a profile of an intended target or profiles of multiple intended targets associated with each advertisement. For example, an advertisement for a travel package to Scotland could have a single intended target of customers with Scottish surnames, or multiple intended targets, such as customers with Scottish surnames, customers that exchange telephone calls with locations in Scotland, and customers who are golf enthusiasts.

In a particular embodiment, the video server(s) 180 can receive requests from the set-top box devices 116, 124 for video content of one or more television programs. The video server(s) 180 can recognize advertisement insertion points, such as cue tones or other cues, in the video content transmitted or to be transmitted to the set-top box devices 116, 124. Upon recognizing such advertisement insertion points, the video server(s) 180 can issue one or more requests to the advertisement server(s) 182 to receive one or more advertisements. For instance, the video server(s) 180 can issue a request to the advertisement server(s) 182 for one or more first advertisements to be inserted at one or more first advertisement insertion points into a first video stream being sent to the IP address of the first representative set-top box device 116. Similarly, the video server(s) 180 can issue a request to the advertisement server(s) 182 for one or more second advertisements to be inserted at one or more second advertisement insertion points into a second video stream being sent to the IP address of the second representative set-top box device 124. Each request can include an IP address or other identifier of the set-top box device to which a requested advertisement is to be sent.

The advertisement server(s) 182 can select the first advertisement(s) based on the customer profile associated with the IP address of the first representative set-top box device 116 at the advertising system data store(s) 186, and the second advertisement(s) based on the customer profile associated with the IP address of the second representative set-top box device 124 at the advertising system data store(s) 186. In an illustrative embodiment, the advertisement server(s) 182 can issue a query to the advertising system data store(s) 186 to receive a recommendation or selection of a targeted advertisement to be sent to a set-top box device identified in a request from the video server(s) 180. The advertising system data store(s) 186 can compare a customer profile associated with the identified set-top box device to intended target information related to advertisements stored at the advertisement server(s) 182. The advertising system data store(s) 186 can send recommendations or selections of targeted advertisements to be sent to the set-top box devices 116, 124 to the advertisement server(s) 182, where the customer profile associated with a set-top box device at least partially matches intended advertisement target information associated with the targeted advertisements recommended for that set-top box device. The advertisement server(s) 182 can select advertisements based on the recommendation or selection received from the advertising system data store(s) 186 and send video content of the selected advertisement to the video server(s) 180.

The video server(s) 180 include the video content of selected advertisements with the video streams being sent to the IP addresses of corresponding set-top box devices 116, 124. In an illustrative, non-limiting embodiment, the advertisement server(s) 182 can transmit the selected advertisement(s) to the video server(s) 180 via the splicer 184, and the splicer 184 can splice the video content of the selected advertisements into the video streams being sent by the video server (s) 180 to each set-top box device. In another embodiment, video content of advertisements can be pushed to the set-top box devices 116, 124, and the set-top box devices 116, 124 can splice video content of each advertisement into video content of television programming at an advertisement insertion point. For example, video content of each advertisement can include tags or other indicators that identify an advertisement insertion point, such as the 52:30 point of NBC's ‘ER,’ at which the advertisement is to be inserted into television programming video content by the set-top box device.

In a particular embodiment, the local switch of the access network 166 can determine and record whether the set-top box device of an intended advertisement target was tuned to a network on which a targeted advertisement was shown during all of the targeted advertisement, a portion of the targeted advertisement, or none of the targeted advertisement. Such ad viewership information can be stored at the access network 166 and can be used to update customer profiles. Aggregated viewership information, non-aggregated viewership information, updated profiles, or any combination thereof, can be sent from the access network 166 to the advertising system data store(s) 186.

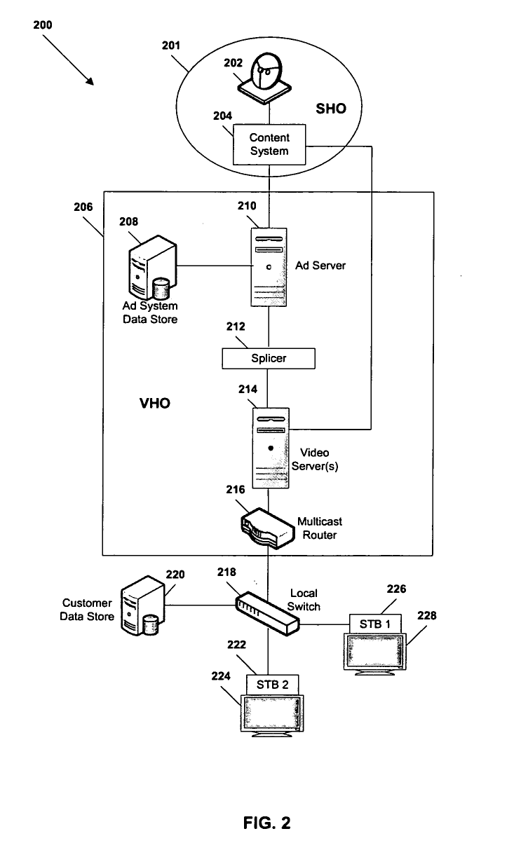

Referring to FIG. 2, a second particular embodiment of a system to provide targeted advertisements is illustrated and designated generally at 200. The system 200 includes a video acquisition system 201 that communicates with a video head end office (VHO) 206 of an Internet Protocol Television (IPTV) system. In an illustrative embodiment, the video acquisition system 201 can be within a satellite head-end office (SHO) and can include a satellite dish 202 coupled to a content system 204. The content system 204 can include, for example, a low-noise blockdown (LNB) converter that is coupled to or integrated with a satellite signal decoder that extracts video content from a satellite signal.

In an illustrative embodiment, the content system 204 communicates advertisements received at the video acquisition system 201 to one or more advertisement servers 210 at the VHO 206. The advertisement server(s) 210 can be coupled to one or more advertising system data stores 208. The advertising system data store(s) 208 can store information associated with advertisements stored at the advertisement server(s) 210, such as advertisement identifiers, advertisement lengths, advertisement subject matter, advertiser name, product name, profiles of intended advertisement targets, intended advertisement insertions points (i.e., networks, times, programs, or any combination thereof), other information related to advertisements stored at the advertisement server(s) 210, or any combination thereof. Further, the advertising system data store(s) 208 can associate one or more advertisement identifiers or other advertisement information with customer profile/IP address combinations received from a customer data store 220 via a local switch 218 of the IPTV system.

The content system 204 communicates video content of television and movie programs to one or more video servers 214 at the VHO 206. In an illustrative embodiment, the video server(s) 214 can be the video server(s) 180 illustrated in FIG. 1. The video server(s) 180 feed video streams via a local switch 218 to at least a first set-top box device 222 and a second set-top box device 226 for display at display devices 224, 228. In an illustrative, non-limiting embodiment, the video server(s) 214 can feed a video stream to many set-top box devices via many local switches, via a multicast router 216.

In a particular embodiment, the local switch 218 can be coupled to a customer data store 218. The customer data store 218 stores customer information associated with the first set-top box device 222 and the second set-top box device 224. In an illustrative embodiment, the customer data store 218 can develop customer profiles from the customer information and associate each customer profile with an IP address of a set-top box device. For example, the customer data store 218 can associate a first customer profile with an IP address of the first set-top box device 222. Further, the customer data store 218 can associate a second customer profile with the IP address of the second set-top box device 226. The customer data store 218 sends the profiles and associated IP addresses to the advertising system data store 208 at the VHO 206.

In an illustrative embodiment, the video server(s) 214 can receive requests from the set-top box devices 222, 226 for video content of one or more television programs. The video server(s) 214 can recognize advertisement insertion points, such as cue tones or other cues in a video stream, in the video content transmitted or to be transmitted to the set-top box devices 222, 226. Upon recognizing such advertisement insertion points, the video server(s) 214 can issue one or more requests to the advertisement server(s) 210 to receive one or more advertisements. For instance, the video server(s) 214 can issue a request to the advertisement server(s) 210 for one or more first advertisements to be inserted at one or more first advertisement insertion points into a first video stream being sent to the IP address of the first set-top box device 222. Similarly, the video server(s) 214 can issue a request to the advertisement server(s) 210 for one or more second advertisements to be inserted at one or more second advertisement insertion points into a second video stream being sent to the IP address of the second set-top box device 226.

Each request can include an IP address or other identifier of the set-top box device to which the requested advertisement(s) will be sent. The advertisement server(s) 210 can select the first advertisement(s) based on the customer profile associated with the IP address of the first set-top box device 222 at the advertising system data store(s) 208, and the second advertisement(s) based on the customer profile associated with the IP address of the second set-top box device 226 at the advertising system data store(s) 208.

In a particular embodiment, the advertisement server(s) 210 can issue a query to the advertising system data store(s) 208 to receive recommendations or selections of targeted advertisements to be sent to a set-top box device identified in a request from the video server(s) 214. The advertising system data store(s) 208 can compare a customer profile associated with the identified set-top box device to intended target information related to advertisements stored at the advertisement server(s) 210. The advertising system data store(s) 208 can send recommendations or selections of one or more targeted advertisements to be sent to the set-top box device to the advertisement server(s) 210, where the customer profile associated with the set-top box device at least partially matches intended advertisement target information associated with the targeted advertisements. The advertisement server(s) 210 can select one or more advertisements based on the recommendation or selection received from the advertising system data store(s) 208 and send video of the selected advertisement(s) to the video server(s) 214.

In a particular embodiment, the advertisement server(s) 210 transmit selected advertisements to the video server(s) 214, and the video server(s) 214 place the advertisements into video streams being sent to the set-top box devices 222, 226. In an illustrative, non-limiting embodiment, the advertisement server(s) 210 can transmit the selected advertisements to the video server(s) 214 via the splicer 212. The video streams containing the targeted advertisements are dispatched to the IP addresses of the set-top box devices 222, 226 via the local switch 218.

In a particular embodiment, the local switch 218 can determine and record whether the set-top box device of an intended advertisement target was switched to a network on which a targeted advertisement was shown during all of the targeted advertisement, a portion of the targeted advertisement, or none of the targeted advertisement. Such ad viewership information can be stored at the customer data store 220 and can be used to update customer profiles. Aggregated viewership information, non-aggregated viewership information, updated profiles, or any combination thereof, can be sent from the customer data store 220 to the advertising system data store 208 via the local switch 218.

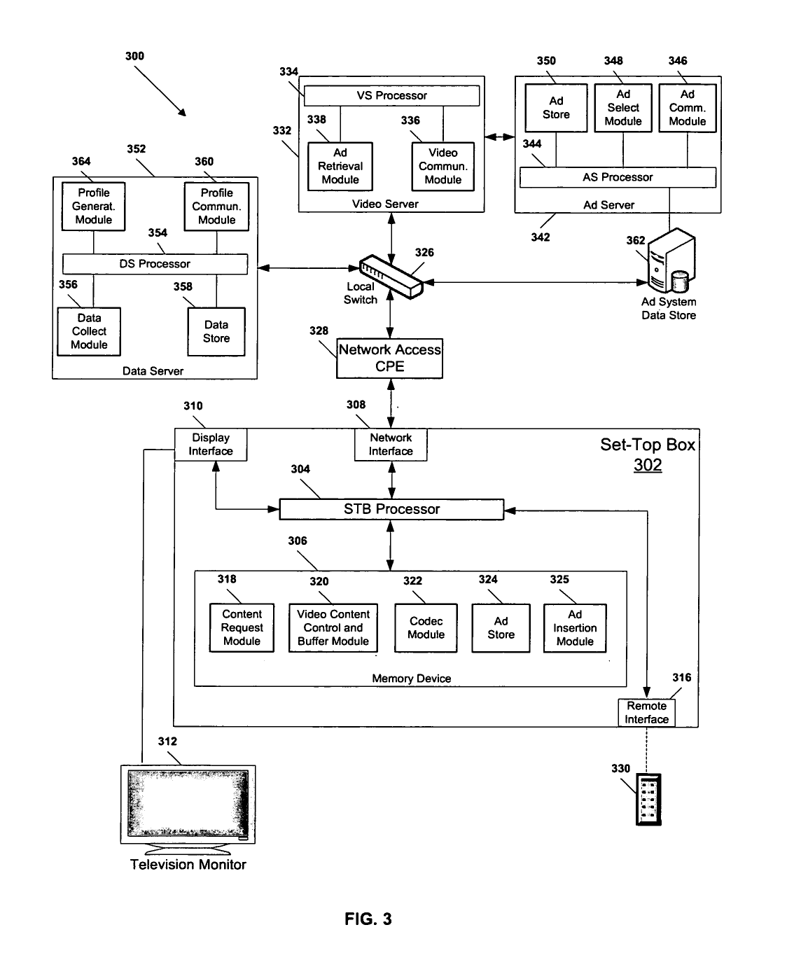

Referring to FIG. 3, a third particular embodiment of a system to provide one or more targeted advertisement is illustrated and designated generally at 300. The system 300 includes a set-top box device 302 that communicates with a video server 332 of an Internet Protocol Television (IPTV) system via a local switch 326 of an IPTV access network. In a particular embodiment, the local switch 326 is coupled to a data server 352 that stores customer information, including account information and other information related to a customer associated with the set-top box device 302. Further, the video server 332 is coupled to an advertisement server 342 that stores advertisements and communicates with a advertising system data store 362 to target stored advertisements to set-top box devices. In an illustrative, non-limiting embodiment, the local switch 326 can communicate directly with the advertising system data store 362.

As indicated in FIG. 3, the set-top box device 302 includes a STB processor 304 and a memory device 306 accessible to the STB processor 304. In an illustrative, non-limiting embodiment, the STB processor 304 can communicate with a local switch 326 of an external access network, such as an IPTV access network, via the network interface 308. In a particular embodiment, network access customer premises equipment (CPE) 328 can facilitate communication between the network interface 308 and the local switch 326. The network access CPE 328 can include a router, a local area network device, a modem, such as a digital subscriber line (DSL) modem, any other suitable device for facilitating communication between the network interface 308 of the set-top box device 302 and the local switch 326, or any combination thereof. Further, the STB processor 304 can communicate video content to a display device 312 via a display interface 310. In addition, the STB processor 304 can receive commands from a remote control device 330 via a remote interface 316.

In a particular embodiment, the memory device 306 can include a content request module 318 that is executable by the STB processor 304 to receive a request for video content from a user via the remote control device 330. For example, the request can be a channel change request or a video-on-demand request. The content request module 318 can be executable by the STB processor 304 to request and receive the video content from the video server 332 via the local switch 326. The memory device 306 can also include a video content control and buffer module 320 that is executable by the STB processor 304 to receive video content requested by a user and to buffer the video content before transmitting it to the display interface 310, in order to prevent underflow. Further, the memory device 306 can include a codec module 322 that is executable by the STB processor 304 to decode video streams received from the IPTV system via the local switch 326 prior to transmitting the video streams to the display device 312.

In a particular embodiment, the memory device 306 can include an advertisement store 324 to store video content of advertisements received with video content. Further, the memory device 306 can include an advertisement insertion module 325 that is executable by the processor 304 to splice or otherwise insert video content of one or more advertisements stored in the advertisement store 324 into video content sent to the display device 312 from the video content control and buffer module 320.

In a particular embodiment, the video server 332 can include a VS processor 334. The video server 332 can include a video communication module 338 that is executable by the VS processor 334 to receive video content, for example, from an acquisition system or D-server, and to transmit the content to the set-top box device 302 via the local switch 326. In addition, the video server 332 can include an advertisement retrieval module 336 that is executable by the VS processor 334 to recognize one or more advertisement insertion points in a video stream being sent to a set-top box device and to request one or more advertisements from the advertisement server 342. In an illustrative embodiment, the video communication module 338 can be executable by the VS processor 334 to include video content of each advertisement with the video stream to be transmitted to the set-top box device 302 or to multiple set-top box devices. In an illustrative embodiment, the various modules 336, 338 of the video server 332 can be included in a memory device of the video server 332.

In a particular embodiment, the advertisement server 342 can include an AS processor 344. Further, the advertisement server 342 can include an advertisement communication module 346 that is executable by the AS processor 344 to receive advertisements from an acquisition system and to store the advertisements in an advertisement store 350. The advertisement server 342 can also include an advertisement selection module 348 that is executable by the AS processor 344 to select an advertisement from the advertisement store 350 based on intended advertisement target information associated with each advertisement in the advertisement store 350, as well as a customer profile associated with an IP address of a set-top box device for which one or more advertisements are requested by the video server 332. The customer profile, IP address, and intended advertisement target information can be stored at the advertisement server 342, at the advertising system data store 362, or any combination thereof. In an illustrative embodiment, the advertisement selection module 348 can be executable by the AS processor 344 to communicate selected advertisements to the video server 332. In an illustrative embodiment, the various modules 346-350 of the advertisement server 342 can be included in a memory device of the advertisement server 342.

In a particular embodiment, the data server 352 can include a DS processor 354. Further, the data server 352 can include a data collection module 356 that is executable by the DS processor 354 to collect data associated with the set-top box device 302, such as requested video content, channel selections, viewership of television programs, viewership of movies, viewership of commercial advertisements, other data, or any combination thereof. Further, the data collection module 356 can be executable by the DS processor 354 to receive customer information, such as account information, demographic information, location information, other customer information, or any combination thereof, from a subscriber store, communication server, or other device within the IPTV system via the local switch 326. The data collection module 356 can be executable by the DS processor 354 to store the customer information in a data store 358. The data store 358 can also store IP addresses associated with set-top box devices served by the local switch 326.

In an illustrative embodiment, the data server 352 can include a profile generation module 364 that is executable by the DS processor 354 to develop a customer profile based on customer information associated with the set-top box device 302. Additionally, the profile generation module 364 can be executable by the DS processor 354 to associate the customer profile with the IP address of the set-top box device 302. Further, the data server 352 can include a profile communication module 360 that is executable by the DS processor 354 to communicate the customer profile and associated IP address to the advertising system data store 362 via the local switch 326. In an illustrative embodiment, the various modules 356-360, 364 of the data server 352 can be included in a memory device of the data server 352.

In an illustrative embodiment, the video server 332 can receive a request for video content corresponding to particular television programming. The video server 332 can recognize one or more advertisement insertion points in the video content indicating that an advertisement is to be inserted into a video sequence. Upon recognizing the advertisement insertion point(s), the video server 332 issues a request to the advertisement server 342 for one or more advertisements. The request includes an IP address or other identifier of the set-top box device 302. In an illustrative embodiment, the advertisement server 342 can select the advertisement(s) based on a customer profile associated with the IP address of the set-top box device 302 at the advertising system data store 362.

The advertisement server 342 transmits the selected advertisement(s) to the video server 332, and the video server 332 sends video content of the advertisement(s) with the video stream being sent to the set-top box device 302. In an illustrative, non-limiting embodiment, the video content of each advertisement can include a tag or other indicator that describes an advertisement insertion point, such as the 06:47 point of ABC's ‘LOST.’ The set-top box device 302 can splice or otherwise insert the video content of the advertisement(s) into the video content of television programming at the indicated advertisement insertion point(s), before sending the video content of the television programming to the display device 312.

In a particular embodiment, the local switch can determine and record whether the set-top box device of an intended advertisement target was tuned to a network on which a targeted advertisement was shown. Such advertisement viewership information can be stored at the data server 352 and can be used to update customer profiles. Aggregated viewership information, non-aggregated viewership information, updated profiles, or any combination thereof, can be sent from the data server 352 to the advertising system data store 362 via the local switch 326.

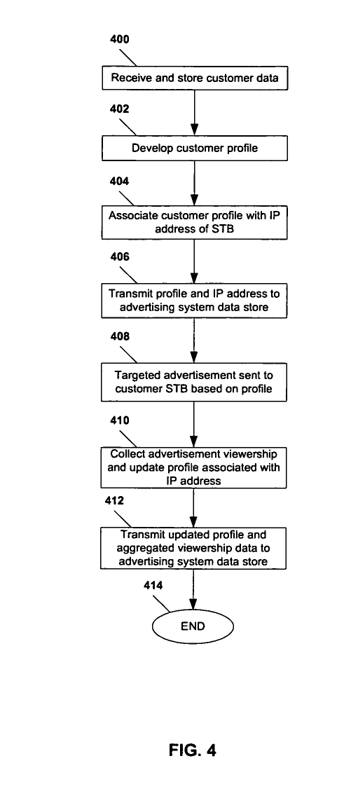

Referring to FIG. 4, a particular embodiment of a method of providing one or more targeted advertisements is illustrated. At block 400, a customer data store receives customer information corresponding to a subscriber or other customer associated with a set-top box device that receives video content from an Internet Protocol Television (IPTV) system. In an illustrative embodiment, the customer information can be received at a subscriber and system store, communication server, or other device of the IPTV system, such as the subscriber and system store 148 or communication server 190 illustrated in FIG. 1. In another embodiment, the customer information can be stored at a customer data server that communicates with a local switch of the IPTV system, such as the customer data store 220 illustrated in FIG. 2 or the data server 352 illustrated in FIG. 3.

In an illustrative embodiment, customer information can be received or collected from the customer, for example, via a set-top box device or computing device that communicates with the IPTV system. In another embodiment, the data can be received at the customer data server from the subscriber and system store 148 or communication server 190 illustrated in FIG. 1. Customer data can include viewing habits at the customer's set-top box device; age, gender, marriage, children or other demographic information of the customer, other users of the customer's set-top box device, or any combination thereof; and other information related to preferences or interests associated with the customer, other users of the customer's set-top box device, or any combination thereof. In a particular embodiment, the customer information can include telephone call history data associated with the customer, other users of the customer's set-top box device, or any combination thereof; or Internet viewing habits associated with customer, other users of the set-top box device, or any combination thereof.

Moving to block 402, in an illustrative embodiment, customer information stored at the customer data store is used to develop a customer profile. For instance, a customer profile can predict or otherwise indicate, for example, needs, wants, preferences, interests, or any combination thereof, for goods, services, or any combination thereof, at a customer's household. At block 404, the customer profile is associated with an IP address corresponding to the customer's set-top box device. Proceeding to block 406, the customer profile and associated IP address are sent from the customer data store to a data store of an advertising system. In an illustrative embodiment, the customer profile and associated IP address can be sent to an advertisement server of the IPTV system. The advertisement server can store the customer profile and associated IP address or communicate the customer profile and associated IP address to a data store coupled to the advertisement server, such as the advertising system data store illustrated in FIGS. 1-3. In another embodiment, the customer profile and associated IP address can be sent directly to a data store coupled to the advertisement server by the customer data store or by a data server or switch coupled thereto.

Continuing to block 408, in a particular embodiment, a targeted advertisement is transmitted to the customer's set-top box device. In an illustrative embodiment, the targeted advertisement is selected by an advertisement server of the IPTV system based on the customer profile associated with the IP address of the set-top box device. The targeted advertisement can be inserted into a video stream that is sent to the set-top box device by a video server or other device of the IPTV system.

Advancing to block 410, in a particular embodiment, the customer data store collects and stores viewership information related to the targeted advertisement. For example, the customer data store can determine whether the entire targeted advertisement, none of the targeted advertisement, or a portion of the targeted advertisement, was viewed at the customer's set-top box device. In an illustrative embodiment, the viewership information can be used to update the customer's profile, for instance, with respect to interests, viewing habits, or other information associated with the customer's profile.

Moving to block 412, in an illustrative, non-limiting embodiment, an updated profile that includes or is based on collected viewership information can be associated with the IP address of the customer's set-top box device, and the updated profile and IP address can be sent to the advertising system data store. In another embodiment, the customer data store can aggregate viewership information and statistics related to an advertisement, for instance, where the advertisement has been targeted to many customers served by a local switch or other device of the IPTV system. Such aggregated viewership data can be sent to the advertising system data store for analysis by or transmission to advertisers or other parties. The method terminates at 414.

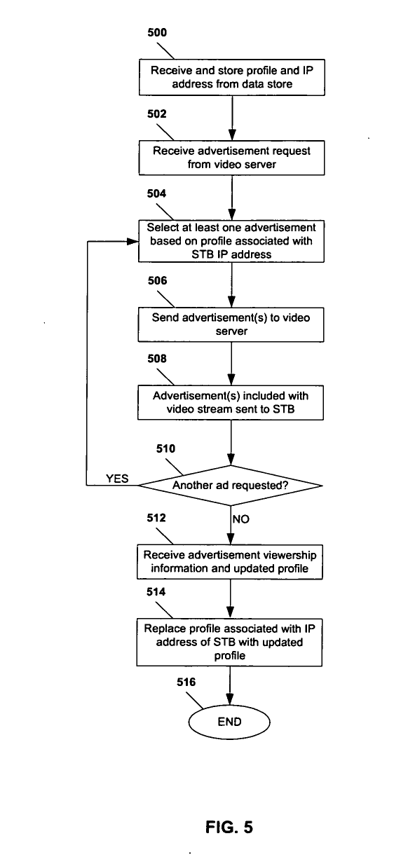

Referring to FIG. 5, a second particular embodiment of a method of providing one or more targeted advertisements is illustrated. At block 500, a profile and associated set-top box IP address are received from a data store or server at an advertising system data store within an Internet Protocol Television (IPTV) system. The profile is based on information corresponding to a customer of the set-top box device, other users of the set-top box device, or any combination thereof. In an illustrative embodiment, the profile and associated IP address can be received at an advertisement server of the IPTV system. The advertisement server can store the profile and associated IP address or communicate the profile and associated IP address to a data store coupled to the advertisement server, such as the advertising system data store illustrated in FIGS. 1-3. In another embodiment, the profile and associated IP address can be sent directly to the advertising system data store by the data store or server, or from a switch coupled thereto.

Moving to block 502, the advertisement server receives a request to send an advertisement to a video server of the IPTV system. In an illustrative embodiment, the request can include an IP address or other identifier associated with the set-top box device to which the video server will send the advertisement. Proceeding to block 504, the advertisement server selects at least one advertisement based on the profile associated with the IP address of the set-top box device. For example, the advertisement server can store profiles and intended advertisement target information related to each advertisement that it stores. The advertisement server can select a targeted advertisement by comparing the profile to the intended target information.

In another embodiment, the advertising system data store can store intended target information related to each advertisement stored at the advertisement server. In this embodiment, the advertisement server can query the advertising system data store to receive one or more advertisement selections. The advertising system data store can compare the profile associated with the IP address of the set-top box device that will receive the advertisement to intended target information corresponding to each of the advertisements stored at the advertisement server. The advertising system data store can issue one or more commands, instructions, or selections to the advertisement server identifying an advertisement that has intended target information at least partially matching or matched by the profile.

Continuing to block 506, the advertisement server transmits video content of the selected advertisement(s) to the video server. At block 508, in an illustrative embodiment, video content of the selected advertisement(s) can be inserted into or otherwise included with a video stream that is sent to the set-top box device by the video server or other device of the IPTV system. In a particular embodiment, video content of the selected advertisement(s) can be included with video content sent to multiple set-top box devices that are associated with profiles having one or more similar or matching elements.

Advancing to block 510, in a particular embodiment, the advertisement server can determine whether another advertisement is requested for insertion into the video stream. For example, multiple targeted advertisements can be used for one “commercial break” of a television program. If another advertisement is requested, the method returns to block 504. Conversely, if no additional targeted advertisements are requested, the method moves to block 512.

At block 512, in a particular embodiment, the advertising system can receive an updated profile associated with an IP address of the set-top box device to which the targeted advertisement was sent. The profile can be updated based on viewership information related to the targeted advertisement, such as whether the entire targeted advertisement, none of the targeted advertisement, or a certain portion of the targeted advertisement, was viewed at the set-top box device. In an illustrative, non-limiting embodiment, the advertising system can also receive aggregated viewership information and statistics for an advertisement, for instance, where the advertisement has been targeted to many customers served by a local switch or other device of the IPTV system. Such aggregated viewership data can be sent to the advertising system data store for analysis by or transmission to advertisers or other parties. Proceeding to block 514, the profile associated with the IP address of the set-top box device at the advertising system data store is replaced with the updated profile. The method terminates at 516.

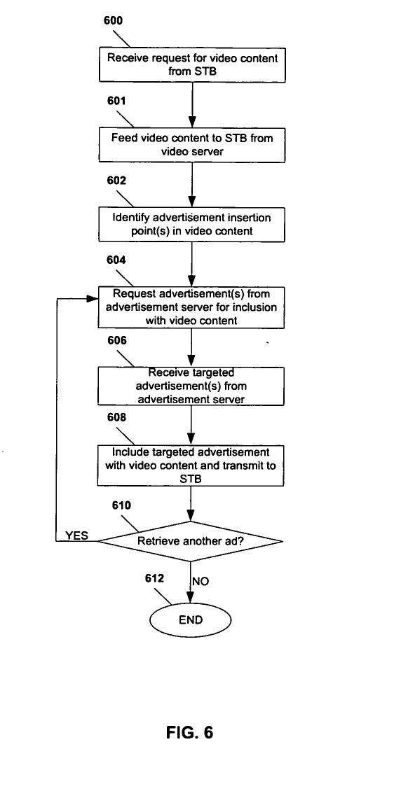

Referring to FIG. 6, a third particular embodiment of a method of providing targeted advertisements is illustrated. At block 600, a video server of an Internet Protocol Television (IPTV) system receives a request for video content, such as a channel or program request, from a set-top box device. Moving to block 601, the video server feeds the video content to the set-top box device via a switch of the IPTV system. Moving to block 602, the video server identifies one or more advertisement insertion points in the video stream. An advertisement insertion point may include a cue tone or other cue coinciding with or before the advertisement insertion point. Alternatively, video content associated with a program, for instance, can include data indicating a number of advertisement insertion points, positions of advertisement insertion points, or any combination thereof related to the program.

Proceeding to block 604, the video server requests one or more advertisements from an advertisement server of the IPTV system. The request can include an IP address of a set-top box device that is to receive the advertisement(s). Continuing to block 606, the video server receives video content of the requested advertisement(s) from the advertisement server. In an illustrative embodiment, the advertisement(s) can be targeted to a customer associated with the IP address of the set-top box device based on a profile of the customer that is created from customer information, such as account information, demographic information, other customer information, or any combination thereof. Advancing to block 608, in a particular embodiment, the video content of the advertisement(s) can be spliced or otherwise inserted into the video content being fed to the set-top box device. In another particular embodiment, the advertisement(s) can be pushed to the set-top box device, and the set-top box device can splice the video content of the advertisement(s) into video content of programming.

At block 610, in a particular embodiment, the video server can determine whether to retrieve another advertisement. For example, multiple targeted advertisements can be inserted during one “commercial break” of a television program. If the video server determines that another advertisement is to be requested, the method returns to block 604. Conversely, if no additional targeted advertisements are to be requested, the method terminates at 612.

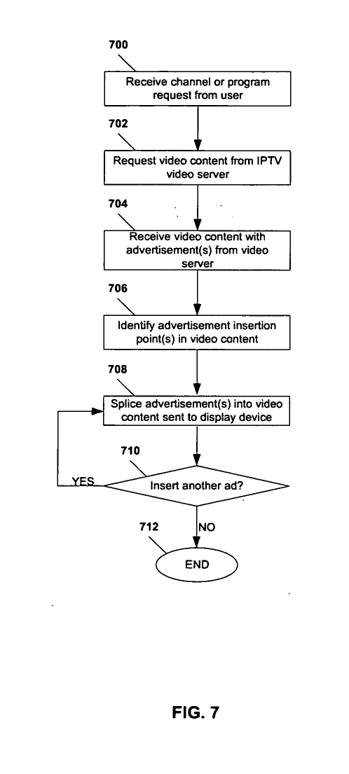

Referring to FIG. 7, a fourth particular embodiment of a method of providing targeted advertisements is illustrated. At block 700, a set-top box device receives a request for a channel, program or any combination thereof, from a user. For example, the request can be received from a remote control device that communicates with the set-top box device. Moving to block 702, the set-top box device requests video content corresponding to television programming, for example, from a video server of an Internet Protocol Television (IPTV) system.

Continuing to block 704, the set-top box device receives the requested video content from a video server via a local switch, access network, or any combination thereof, of the IPTV system. In a particular embodiment, video content of one or more advertisements can be included with the video content of the requested programming. In an illustrative embodiment, the video content of each advertisement can include one or more indicators that identify one or more advertisement insertion points at which the advertisement is to be inserted into video content of the television programming. The advertisement(s) can include one or more targeted advertisements that are selected by an advertisement server or other device of the IPTV system, based on a profile of a customer, other user, or any combination thereof, associated with the set-top box device.

Advancing to block 706, in a particular embodiment, the set-top box identifies one or more advertisement insertion points in the video stream. An advertisement insertion point may include a cue tone or other cue coinciding with or before the advertisement insertion point. Proceeding to block 708, in a particular embodiment, the set-top box device can splice or otherwise insert the video content of the advertisement(s) into the video content of television programming being sent to a display device coupled to the set-top box device.

At block 710, in a particular embodiment, the set-top box device can determine whether to insert another advertisement into the video content of the television programming. For example, multiple advertisements can be inserted during one “commercial break” of a television program. If the set-top box device determines that another advertisement is to be requested, the method returns to block 708 and continues as described. Conversely, if no additional targeted advertisements are to be requested, the method terminates at 712.

In a particular embodiment, the steps of the methods described herein can be executed in the order shown by the figures. In alternative embodiments, some steps can be executed simultaneously or in alternative sequences. For example, a single request for multiple advertisements can be communicated from a video server and received at an advertisement server. In another example, multiple successive requests can be communicated and received before the advertisement server returns any targeted advertisements to the video server.

In conjunction with the configuration of structure described herein, the system and method disclosed provide targeted advertisements based on a variety of information associated with a set-top box device. In an illustrative embodiment, a customer data server coupled to a local switch of an Internet Protocol Television (IPTV) access network can collect customer information, such as account information, demographic information, television viewing habits, and other customer information. In a particular embodiment, the customer information can include Internet viewing habits, telephone call history information, or any combination thereof. In an illustrative, non-limiting embodiment, a service provider can obtain any necessary consents from customers prior to collecting the telephone call history data, Internet viewing habits, or any combination thereof. In another embodiment, the service provider can collect the telephone call history data, Internet viewing habits, or any combination thereof, without such consents, for example, where such consents are not required by regulation.

The customer data server can use the customer information to create a customer profile associated with an IP address of the customer's set-top box device and communicate the profile and IP address to an advertising system of the IPTV system. For example, the customer data server can communicate the customer profile to an advertisement server that stores the customer profile at an advertising system data store. In a particular embodiment, the advertising system data store can also store information and identifiers related to advertisements stored at the advertisement server.

In an illustrative embodiment, a video server of the IPTV system can receive a request for video content, such as television programming, from a set-top box device. The video server can recognize one or more advertisement insertion points in the requested video content. The video server can request one or more targeted advertisements to be inserted into the video content of the television programming from the advertisement server. Upon receiving such a request, the advertisement server, advertising system data store, or any combination thereof, can select one or more targeted advertisements based on the customer profile associated with the IP address of the set-top box device. The advertisement server can send video content of the selected advertisement(s) to the video server, and the video content of the advertisement(s) can be included with the video content of the television programming sent to the set-top box device. In one embodiment, the video content of the advertisement(s) can be spliced or otherwise inserted into the video content of the television programming being fed to the set-top box device. In another embodiment, the video content of the advertisement(s) can be included with the video content of the television programming being fed to the set-top box device, and the set-top box device can splice or otherwise insert the video content of the advertisement(s) into the video content of the television programming.

In a particular embodiment, viewership data corresponding to the advertisement(s) can be collected and used to update the customer profile. Further, aggregated viewership data corresponding to multiple customers receiving the same targeted advertisement(s) can be collected and stored for use by advertisers or other parties.

In an exemplary embodiment, two customers can be watching a single program, such as a football game, at different locations. One of the customer's demographic data, such as a birth date, may indicate that the customer is a retired person. The other customer's billing data may show that he or she is a college student on a university campus. The disclosed system and method can allow an advertiser, such as a car company or beer manufacturer, to promote a luxury car or premium beer to the first customer, while promoting a sports car or light beer to the second customer, during the same commercial break in the football game.

In another exemplary embodiment, two customers could be watching another program, such as a travel program, at different locations. One of the customer's telephone call history data may indicate that the customer calls Mexico frequently. The other customer's Internet viewing data may include Bahamas travel packages. Upon obtaining any necessary consents from the customer, regulatory agencies, or any combination thereof, the disclosed system and method can allow a service provider to advertise a hotel package in Puerto Vallarta to the first customer, while advertising a cruise to the Bahamas to the second customer, during the same commercial break in the travel program.

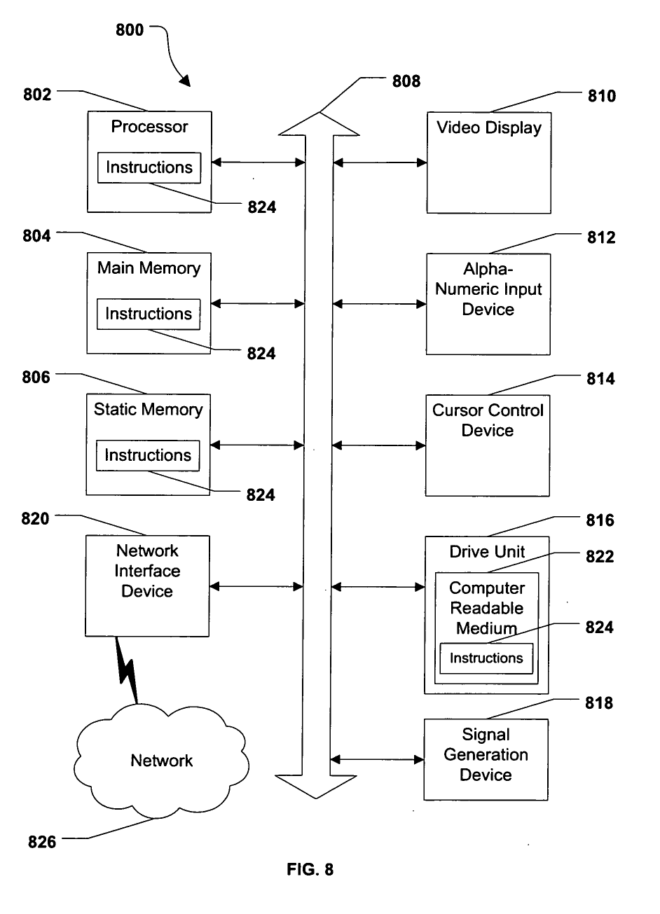

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800, or any portion thereof, may operate as a standalone device or may be connected, e.g., using a network, to other computer systems or peripheral devices, including a server or set-top box device, as shown in FIGS. 1-3.

In a networked deployment, the computer system may operate in the capacity of an IPTV server or set-top box device. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. Further, the computer system 800 can include a wireless input device 815, e.g., a remote control device. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing targeted advertisements, the method comprising:
receiving video content of television programming at a set-top box device from a video server of an Internet Protocol Television (IPTV) system;
receiving video content of a targeted advertisement at the set-top box device from the video server with the video content of the television programming, wherein an advertisement server of the IPTV system selects the targeted advertisement based on a customer profile associated with an identifier of the set-top box device;
recognizing an advertisement insertion point in the video content of the television programming; and
inserting the video content of the targeted advertisement into the video content of the television programming at the advertisement insertion point.

2. The method of claim 1, wherein the set-top box device splices the video content of the targeted advertisement into the video content of the television programming.

3. The method of claim 1, wherein the video content of the targeted advertisement includes data indicating an advertisement insertion point at which the video content of the targeted advertisement is to be inserted into the video content of the television programming.

4. The method of claim 3, wherein the video content of the targeted advertisement is inserted into the video content of the television programming at the indicated advertisement insertion point.

5. The method of claim 1, further comprising:
communicating a request for video content of different television programming to the video server; and
receiving a different targeted advertisement associated with the different television programming, a network of the different television programming, or any combination thereof.

6. A set-top box device, comprising:
a processor and a memory device accessible to the processor;
a buffer to receive video content of television programming from a video server of an Internet Protocol Television (IPTV) system;
an advertisement store to receive video content of a targeted advertisement from the video server with the video content of the television programming, wherein an advertisement server of the IPTV system selects the targeted advertisement based on a customer profile associated with an identifier of the set-top box device; and
wherein the memory device includes an advertisement insertion module executable by the processor to recognize an advertisement insertion point in the video content of the television programming and to insert the video content of the targeted advertisement into the video content of the television programming at the advertisement insertion point.

7. The set-top box device of claim 6, wherein the identifier of the set-top box device includes an Internet Protocol (IP) address.

8. The set-top box device of claim 6, wherein the advertisement insertion module is executable by the processor to insert video content of multiple successive targeted advertisements into the video content of the television programming at the advertisement insertion point.

9. A computer program embedded in a computer-readable medium, the computer program comprising:
instructions to receive video content of television programming from a video server of an Internet Protocol Television (IPTV) system;
instructions to receive video content of a targeted advertisement from the video server with the video content of the television programming, wherein an advertisement server of the IPTV system selects the targeted advertisement based on a customer profile associated with an identifier of the set-top box device; and
instructions to recognize an advertisement insertion point in the video content of the television programming and to insert the video content of the targeted advertisement into the video content of the television programming at the advertisement insertion point.

10. The computer program of claim 9, further comprising instructions to communicate to a data server at an access network of the IPTV system data indicating whether the set-top box device received video content of all of a particular targeted advertisement, none of a particular targeted advertisement, or a portion of a particular targeted advertisement.

11. The computer program of claim 10, wherein the customer profile is at least partially based on whether the set-top box device received video content of all of a particular targeted advertisement, none of a particular targeted advertisement, or a portion of a particular targeted advertisement.

12. A method of providing targeted advertisements, the method comprising:
receiving a customer profile associated with an identifier of a set-top box device at an advertisement server of an Internet Protocol Television (IPTV) system, wherein the customer profile is based at least partially on telephone call history data and indicates a customer preference for at least one product, at least one service, or any combination thereof; and
selecting at least one advertisement in response to a request for at least one advertisement to be sent to the set-top box device, wherein the customer profile at least partially matches an intended target of the at least one selected advertisement.

13. The method of claim 12, further comprising:
storing video content of a plurality of advertisements including video content of the at least one advertisement; and
storing data identifying intended targets of each of the plurality of advertisements.

14. The method of claim 13, further comprising comparing the customer profile with intended target information associated with each of the plurality of advertisements, wherein the intended target information indicates that an advertisement is to be sent to a customer that receives calls from a location, places calls to the location, or any combination thereof.

15. The method of claim 12, wherein the request for the at least one advertisement is received from a video server of the IPTV system.

16. The method of claim 15, further comprising sending video content of the at least one advertisement to the video server, wherein the video content of the at least one advertisement is inserted into video content of television programming sent to the set-top box device.

17. The method of claim 16, further comprising sending the video content of the at least one advertisement to the video server via a splicer.

18. The method of claim 12, further comprising storing the customer profile and identifier at an advertising system data store coupled to the advertisement server.

19. The method of claim 18, further comprising:
requesting a recommendation of an advertisement to be sent to the set-top box device from the advertising system data store, wherein the advertising system data store stores data related to intended targets of a plurality of advertisements;
receiving a recommendation of the at least one selected advertisement from the advertising system data store, wherein the advertising system data store determines that the customer profile at least partially matches the intended target of the at least one selected advertisement; and
wherein the at least one selected advertisement is selected based on the recommendation.

20. A method of providing targeted advertisements, the method comprising:
receiving customer information associated with a set-top box device, wherein the customer information includes telephone call history data;
creating a customer profile based on the customer information;
associating the customer profile with an identifier of the set-top box device; and
sending the customer profile with the identifier to an advertisement server of an Internet Protocol Television (IPTV) system, wherein the advertisement server selects at least one advertisement based on the customer profile and wherein video content the at least one advertisement is included with video content of television programming sent to the set-top box device via an access network of the IPTV system.

21. The method of claim 20, wherein the customer profile is based on customer information that includes television viewing habits, age, gender, other demographic information, Internet viewing habits, other information related to preferences or interests, or any combination thereof.

22. The method of claim 21, wherein the telephone call history data includes locations from which the customer has received calls, locations to which the customer has placed calls, or any combination thereof.

23. The method of claim 20, further comprising:
determining whether the set-top box device received video content of all of the at least one advertisement, none of the at least one advertisement, or a portion of the at least one advertisement; and
updating the customer profile based on whether the set-top box device received video content of all of the at least one advertisement, none of the at least one advertisement, or a portion of the at least one advertisement.

24. A method of providing targeted advertisements, the method comprising:
sending video content of television programming to a set-top box device from a video server of an Internet Protocol Television (IPTV) system;
identifying an advertisement insertion point in the video content of the television programming;
issuing a request to an advertisement server of the IPTV system to receive video content of an advertisement to be sent to the set-top box device, wherein the request includes an identifier of the set-top box device; and
receiving video content of a targeted advertisement from the advertisement server, wherein the advertisement server selects the targeted advertisement based on a customer profile associated with the identifier of the set-top box device, the customer profile including telephone call history data.

25. The method of claim 24, further comprising inserting the video of the targeted advertisement into the requested video content at the advertisement insertion point.

26. The method of claim 24, further comprising multicasting the video of the targeted advertisement to a plurality of set-top box devices, wherein a profile of a customer associated with each of the plurality of set-top box devices at least partially matches one of a plurality of intended targets of the targeted advertisement.

27. A system, comprising:
a video server configured to send video content of television programming to a set-top box device via an access network of an Internet Protocol Television (IPTV) system, wherein the video server includes a processor and a memory device;
wherein the memory device includes instructions executable by the processor to identify an advertisement insertion point in the video content of the television programming and to issue a request to an advertisement server of the IPTV system to receive at least one advertisement to be sent to the set-top box device, the request including an identifier of the set-top box device; and
wherein the memory device includes instructions executable by the processor to insert video content of a targeted advertisement received from the advertisement server into the video content of the television programming, the advertisement server selecting the targeted advertisement based on a profile associated with the identifier of the set-top box device, the profile including telephone call history data.

28. The system of claim 27, wherein the video server is coupled to a multicast device configured to multicasting the video of the targeted advertisement to a plurality of set-top box devices, wherein a profile associated with each of the plurality of set-top box devices at least partially matches intended targets of the targeted advertisement.

29. A computer program embedded in a computer-readable medium, the computer program comprising:
instructions to store video content a plurality of advertisements;
instructions to receive a profile associated with an identifier of a set-top box device of an Internet Protocol Television (IPTV) system, wherein the profile is based at least partially on telephone call history data; and
instructions to select an advertisement from the plurality of advertisements based on the profile, wherein the profile at least partially matches an intended target of the selected advertisement.

30. The computer program of claim 29, further comprising instructions to send video data of the selected advertisement to a video server of the IPTV system.

31. A computer program embedded in a computer-readable medium, the computer program comprising:
instructions to send video content of television programming to a set-top box device via an access network of an Internet Protocol Television (IPTV) system;
instructions to identify an advertisement insertion point in the video content of the television programming and to issue a request to an advertisement server of the IPTV system to receive at least one advertisement to be sent to the set-top box device, the request including an identifier of the set-top box device; and
instructions to insert video content of a targeted advertisement received from the advertisement server into the video content of the television programming, the advertisement server selecting the targeted advertisement based on a profile associated with the identifier of the set-top box device, the profile including telephone call history data.

32. The method of claim 31, wherein the request is issued to the advertisement server in response to a cue tone in the video stream before or coinciding with the advertisement insertion point.
